(19) United States
(12) Patent Application Publication
(10) Pub. No.: US 2006/0265295 A1
(43) Pub. Date: Nov. 23, 2006

(54) Method for objectively monitoring, recording and reporting work-hour compliance of medical and surgical residents

(76) Inventor: Mark A. Feanny, Pearland, TX (US)

Correspondence Address: HERBERT JOE, 2809 Creek Side Drive, Edmond, OK, 73003, US

(21) Appl. No.: 11/136,088

(22) Filed: May 23, 2005

(51) Int. Cl. G07C 1/10

(52) U.S. Cl. 705/32

(57) ABSTRACT

A system of transponders, receivers and data processing and data recording and reporting components, and the associated therewith method for objectively, accurately and passively (without monitored personnel or employer active involvement after installation) monitoring and storing medical and surgical resident attendance at medical facilities, and for facilitating the reporting of such attendance or activities, as well as compliance violations of the Accreditation Council for Graduate Medical Education (ACGME) regulations (for clinical duty hour restrictions) to the resident, the residency program and/or to the ACGME via simple but secured electronic transmissions (e.g., internet via TCP/IP, web and/or wireless based network servers etc.).

### BACKGROUND OF THE INVENTION

1. Field of The Invention

Applicant's invention relates to monitoring, storing and reporting medical and surgical resident attendance while on required clinical duty, in addition to reporting any violations of current regulations.

2. Background Information

The foundation and design of training physicians began in the late 1800's by Dr. William Halsted. By modeling his unique training methods after the German-based system under which he was taught, the term “resident” was born in the United States. Since its inception, the word has become synonymous with extremely long work hours and the arduous and sacrificial commitment to learning the practice and art of medicine. Traditionally, as a resident, the physician in training physically resided in the hospital and remained on-call 24-hours a day in order to be available for all of their patients' medical and surgical needs—hence the word “resident.” As time passed, this system became widely accepted as the standard method of preparing a physician for independent and unsupervised practice. However, this form of teaching concomitantly created an entrenched mindset within the halls of medical educators that this was the only way to train a doctor. For almost a century, this “institutional hazing” has propagated its own existence by training all residents in this manner. While still in practice in some parts of the world, in the United States, this form of training has slowly evolved over time with less stringent requirements. However, with only minor attempts to curtail the amount of time spent on duty, it was not uncommon for residents to work in excess of 120 hours per week during their training and remain continuously in the hospital for days on end. However, this was to eventually change.

In 1984, the tragic death of 18-year old college freshman Libby Zion began a cascade of events that have recently culminated in congressional legislation limiting the work hours of medical and surgical residents. While resident physician error due to sleep deprivation has been implicated as the cause of Ms. Zion's death, the exact reason is controversial. Despite any direct accusations, her father, a New York journalist and former federal prosecutor, ultimately blamed the residency training system as a whole and was paramount in initiating relevant federal legislation.

As a result, then New York State health commissioner Dr. David Axelrod designated Bertrand Bell, a distinguished professor of medicine at the Albert Einstein College of Medicine, as the head of a committee investigating emergency medicine resident training. The Bell Commission subsequently issued reports recommending generalized resident work hour limitations and stricter supervision of medical and surgical residents during their training. However, it is significant that violations of Bell's recommendations were increasing as there were no fiscal or departmental consequences from such (code) violations. In 1989, the recommendations of the Bell Commission became part of the New York State Health Code (Title 10, paragraph 405.4, a/k/a “Code 405”). Limiting resident weekly work hours, night-call frequency, time off and time between shifts were included in the language of Code 405. The Resident Physician Section of the American Medical Association (AMA) has passed a resolution substantially similar to New York's Code 405, and other states are following.

It was not until 1997 that the Accreditation Council for Graduate Medical Education (ACGME), a private professional organization and the governing body for approximately 110 medical specialties in nearly 8,200 residency training programs across the United States representing over 100,000 residents, revisited resident work hour limitations. In an unannounced investigation of New York's compliance with Code 405, the state's Department of Public Health declared that almost every program was in some way in violation of work week guidelines and that over 37% of residents were working beyond the number of hours set forth in the language of the regulations. In their investigation of over 2000 programs in 27 accredited specialties, approximately 12% of programs surveyed were not compliant with duty hour standards with almost 30% of surgical programs in violation of work week guidelines.

In April 2001, a petition was filed by the Committee of Interns and Residents (CIR) in conjunction with the AMA and the American Medical Student Association (AMSA) asking the Occupational Safety and Health Administration (OSHA) to utilize its federal regulatory authority to begin enforcing resident and fellow work hour standards. As a major premise within their petition, the groups claimed that prolonged and excessive duty hours were as significant a risk and posed serious health concerns to physicians in training as any other work place hazard. Utilizing published data, the petition linked sleep deprivation, stressful work environments and excessive duty hours to serious and potentially fatal consequences for the resident. In addition, the claims went on to state that excessive work hours and fatigued residents increased the risk and likelihood of medical errors and, ultimately, the safety of patients. The AMA and CIR's petition asked OSHA to enforce duty hour restrictions in the following manner:
A maximum of 80 hours of clinical duty per week.
A maximum of 24 hours of clinical duty in one shift.
Overnight calls to be limited to shifts every third night.
At least one full 24-hour day off per week.

To date, OSHA has not exercised its authority to federally mandate the recommendations presented by the AMA and CIR. However, they would not be the only group to visit work hour reform.

Just four months later in August 2001, the AMA Resident and Fellow Section (AMA-RFS) held a National Resident Work Hours Exploratory Mandatory Meeting in Washington, D.C. Co-sponsored by the CIR, this meeting represented an unprecedented event bringing together medical specialty societies, organizations and resident and medical student leaders from across the country in an effort to explore and collaborate on potential solutions to resident duty hour conditions. As a result of this meeting, the represented groups successfully outlined a number of goals, obstacles and an agreed-upon plan of action. Rather than relying on one organization to solve a complicated and complex philosophical problem, they chose to compile their resources and search for a solution together.

Prior to creating any formal proposals directly addressing resident duty hours, AMA-RFS stated that in their original bylaws, work hours should be addressed “without regulation by agencies of government” (AMA policy H-310.979, Resident Physician Working Hours and Supervision). Traditionally, the AMA and specifically the AMA-RFS, who has been at the forefront of resident duty hour reform for over the past 25 years, relied upon ACGME to nationally enforce duty hour restriction recommended as a result of Code 405. While previously supporting the efforts of ACGME to intervene when necessary, the AMA and AMA-RFS have begun to believe that they may not be capable of adequately enforcing the Residency Review Committee's (RRC) work hour standards. While ACGME and the 27 RRCs are not legislative entities, they are responsible for accrediting residency training programs throughout the country to ensure their compliance in providing adequate teaching, ethical conduct and standards of care in medical practice and training. The RRC is responsible for creating specialty specific regulations and guidelines. In conjunction with ACGME, the RRC ensures that these guidelines are met by every specialty in which they represent at every program in the U.S. While training in residency programs may continue without ACGME/RRC accreditation, programs and hospitals can lose Medicare Graduate Medical Education (GME) funding. Consequently, unaccredited graduating residents are no longer eligible to sit for state board exams in order to practice in the private sector. While accreditation is voluntary by residency programs, without there is almost no use in having residents because the program does not receive federal money for them or are they eligible to sit on state board exams for licensing purposes.

As a result, the AMA-RFS assembly adopted Governing Council Report F, which asked the AMA to comprehensively address and take a more active role in resident duty hour restriction. Their recommendations were as follows:
The AMA may draft original, modify existing, or oppose legislation and pursue regulatory or administrative strategies when dealing with resident work hours and conditions.
The AMA continues to work with organizations like the Accreditation Council on Graduate Medical Education (ACGME) and the Joint Commission on the Accreditation of Healthcare Organizations (JCAHO) toward finding solutions to the problem of work hours and conditions that would strengthen current work hours enforcement mechanisms.
The AMA should encourage the Agency for Healthcare Research and Quality (AHRQ) to examine the link between resident work hours and patient safety, and to explore possible solutions to the problem of work hours and conditions.
These recommendations should be forwarded to the House of Delegates.

The first formal act as a result of these recommendations occurred in September 2001 at the fall meeting of the ACGME. At that meeting, the ACGME officially declared a resolution to create a group with the specific charge of better defining the overall problem of resident duty hour, creating more standard requirements across all medical and surgical specialties and formulating the ACGME's response to federal regulatory and legislative proposal concerning resident work and duty hours.

In October 2001 the AMA Council on Medical Education and the American Academy of Sleep Medicine cosponsored a forum on the “Sleep, Fatigue, and Medical Training; Optimizing Learning and the Patient Care Environment” in Washington, D.C. This workshop was an opportunity for the experts in the fields of patient safety, medical education, hospital administration, residency groups, medical ethics, government and sleep medicine to present scientific information and studies and begin constructive dialogues in an effort to collectively address resident duty hour restriction.

In November 2001, after a combined effort with the collaboration and support of the AMSA and CIR, House Resolution H.R. 3236 was introduced by Congressman John Conyers, Jr. (D-MI). “The Patient and Physician Safety and Protection Act of 2001” was presented to the House of Representatives Committee on Energy and Commerce and the Committee on Ways and Means. While the overall guidelines were very similar to the Code 405 regulations, there were some significant differences. Within the language of this legislation, title XVIII of the Social Security Act would be amended to reduce the work hours and increase the supervision of residents to ensure patient and physician safety. As a condition to receive Medicare funding, the life-blood of residency training programs and currently the decision of the Joint Commission on Accreditation of Healthcare Organizations (JCAHO), the nation's predominant standard setting and independent non-profit organization, the legislation would require hospitals to enforce the following restrictions of resident duty hours:
A maximum of 80 hours of clinical duty per week, or,
A maximum of 24 hours of clinical duty in one shift.
Overnight call limited to no more than one every third night.
At least one day in seven off per week.
At least one full weekend off per month.
If in the ED, no more than 12 consecutive hours on clinical duty.
At least 10 hours off clinical duty between shifts.
   In an effort to assist programs in complying with the language set forth in the respective bills, there are provisions for additional federal funding for departments to implement necessary changes to ensure compliance of the 80-hour work week.

In 2002, U.S. Senator Jon Corzine (D-NJ) introduced Senate Bill S 2614, which is almost identical to HR 3236 and became known as the “Patient and Physician Safety and Protection Act of 2002.” No major action was taken on either bill beyond being sent to committee for debate. Both bills were reintroduced in the 108^{th} Congress as S 952 and HR 1228, amended to include program requirements for designating an individual within the department to handle all complaints of violations arising from residents and whistle blower protection from departments. In addition, within the newer language of HR 1228 and S 952, new and severe civil penalties of a maximum of $100,000 every 6 months could be imposed on programs that fail to comply with duty hour restrictions. With no committee or floor action taken in 2004 on either HR 1228 or S 952, Representative Conyers has, on Mar. 10 of 2005 during the 109^{th} Congress, reintroduced HR 1228 as a major priority of his agenda. With most major programs having on average of 15 subspecialties within their institution, this legislation could mean fines of up to $3M annually per institution for non-compliance.

In order to avoid governmental regulation of medical graduate training and after extensive and successful lobbying efforts by the AMA, AMA-RFS and AMA-MSS, the ACGME began an earnest effort to actively create standard comprehensive guidelines for resident duty hours nationwide. This resulted in the adoption of the following common program requirements from the ACGME:
A maximum of 80 hours of clinical duty per week (averaged over a 4 week period).
A maximum of 24 hours of clinical duty in one shift with 6 additional hours for transfer of patient information during which time no new patients were to be accepted by the resident in question.
Overnight call limited to no more than one every third night (averaged over a 4 week period).
At least one complete 24-hour period free from clinical duties in a seven day period (averaged over a 4 week period).
At least 10 hours off clinical duty between shifts.

These guidelines were adopted by the organizations which comprise the ACGME and the ACGME's board of directors as a result of pressure from the AMA and its affiliates. In February 2003, ACGME finalized the 80-hour work week guidelines and informed programs nationwide that they would go into effect starting Jul. 1, 2003.

Of the over 7,800 programs the ACGME accredits, 1,753 were visited from July 2003 to June 2004. During those 11 months, 84 programs were cited for violations related to work-hour regulations. More shocking, only two weeks after the new guidelines went into effect; medical residents had reported 49 work-hour violations with the ACGME against residency programs. As a result the ACGME was required to spend the crucial funds and commit other limited and valuable resources to accomplish the following:
14 programs were to be monitored at their next site visit.
11 complaints were dismissed for a lack of evidence; however, each one of these claims had to be investigated and proven false prior to their dismissal.
8 site visits were scheduled immediately.
6 investigations are pending due to lack of ancillary staff support to complete the investigation.
5 complaints were reviewed by residency review committees without site visits.
2 program progress reports were requested.
1 program was placed on probation.
1 program was recommended for probation.
1 program was warned and put on a shortened site-visit cycle.

The costs and resources associated with this type of widespread enforcement are enormous. Given the amount of false reporting, many additional programs were in violation, but “slipped through the cracks.”

The ACGME disciplined its first residency program on Aug. 20, 2003: Johns Hopkins University's internal medicine residency program received notice that its accreditation would be summarily withdrawn if supporting documentation demonstrating its compliance with the new duty hour requirement was not provided within 45 days. The general surgery department of the Martin Luther King Jr./Drew Medical Center was similarly disciplined.

To maintain accreditation, these and many other institutions must abide with the new ACGME duty hour guidelines on resident work hours that went into effect Jul. 1, 2003. For example, also in 2003, New York State public health law was amended by addition of a new stipulation requiring hospitals to submit to the Commissioner of Health their plan of compliance with the 405 Regulations regarding working conditions and limits on working hours for residents. The amendments allow for the Commissioner to audit each hospital annually for compliance with its plan. If there is a finding of noncompliance, the Commissioner can issue a civil penalty of $6000 for each instance of noncompliance identified in an initial audit. Upon receipt of written notice of noncompliance, a hospital has thirty days to submit a plan of correction. If the hospital fails to substantially adhere to its plan of correction within 180 days of the initial finding of noncompliance, a civil penalty of $25,000 will be assessed upon a written finding by the Commissioner. Subsequent written findings of noncompliance within 360 days of the initial finding will lead to multiple $50,000 fines.

Additional states are following suit with civil penalties being the new method of ensuring residency program and hospital compliance. On Jun. 6, 2003, State Senator James Vaughn (D-DE), in response to the shortcomings apparent in the ACGME's enforcement, introduced S 133. This legislation was similar to HR 1228 and S 952 and like the proposed federal bill provided no opportunities for averaging and also did not address non-patient duties, such as educational meetings and moonlighting guidelines. State Senator Richard Moore (D-MA) in 2003 also introduced a duty hour bill, Senate No. 604, into the state Senate. While similar to HR1228 and S 952, his bill increases time off after a full 24-hour call night from 10 to 16 hours and demands at least one weekend off per month. In March of 2004 this bill was sent to the Senate Ways and Means Committee. In 2004, similar state legislation was re-introduced into the state's senate and the New Jersey Assembly, which was based on earlier bills restricting resident duty hours. State Senator Michael Stack (D-PA) introduced S 775 in June 2003 which along with similar standard guidelines set forth in the majority of these state bills, charges programs $5,000 for the first violation and $10,000 for each subsequent offense. And finally, New York, the source of this entire debate and legislation, has revisited their original Bell Recommendations and has introduced HCRA 2000. This bill has been passed in the New York legislature and cites programs civil penalties of $6,000 per violation and $50,000 for every repeat violation. This is a current trend in state offices around the country. This is sending a clear message to the ACGME and the RRC: accurately and effectively monitor what the residents are doing or the government will do it for you.

To date, in order to ensure compliance with the ACGME guidelines most residency programs rely on weekly or monthly resident surveys in an effort to log work hours. Of very significant note is that these surveys are self-reported. This, however, has proven to be a dismal method of accurately determining the number of hours worked by a department's residents. This claim has been substantiated by numerous reports from the medical literature stating that actual time on duty and reported time on duty does not match up when submitted by the resident themselves. Invariably, residents forget, lose or simply choose not to complete these “time-sheets,” which are crucial to the department's continuation of accreditation. In addition, there is immense pressure on residents to consistently falsify time sheets to reflect lower work hours, although they continue to actually violate ACGME work hour regulations with impunity.

With the pressure of staff physicians from a by-gone era of 120+ hour work week schedules, residents must function effectively in an overly rigorous and malignant environment just to maintain optimum training given the time restrictions they face. Routinely, residents are admonished from program chairmen and program directors (much like a president and VP) when they violate any of these guidelines, which further encourages false, inaccurate or incomplete reporting. In cases where time sheets are not turned in, residents have had clinical privileges revoked or suspended until such documents are presented. In an effort to reinstate their privileges, residents will turn in anything just to get back to work and take care of their patients. This, in addition to numerous examples of staff physicians “punishing” residents for leaving in order to maintain 80 hour work week compliance (such as not allowing them to operate, forcing them to round on patients instead of joining them in the operating room, not allowing them to perform tasks which they would be able to do if they had been with the staff physician, etc.), has further fueled false reporting immensely.

The ACGME has made a historical change in training residents by implementing these regulations and has taken drastic measures in order to ensure their compliance. While the ACGME and RRC schedule regular periods of internal program review in an effort to ensure compliance with all guidelines, in light of these new regulations, unannounced site visits have become commonplace. These internal audits and “surprise spot inspections” of patient records with comparison of resident timesheets in order to verify accuracy and objectivity are just some of numerous examples of how the ACGME has gone to great lengths—and expense—to ensure that residents do not work over 80 hours per week in order to avoid federal regulation of these mandates. This alone has further instigated the widespread false reporting of work hours by residents to their respective programs. There is simply too much pressure on the residents to function effectively.

Something must be done to take the responsibility off of them and placed back on those responsible for their training. Residents are too busy worrying about the number of hours they work every week as opposed to focusing on patient care. Without an easy, accurate, objective and somewhat inconspicuous way to monitor a resident's duty hours, the patients have become the new victims in this new duty hour environment. False reporting has gotten out control. Within the AMA website, residents are encouraged to provide reports of duty hour violations in an anonymous forum given no current whistle blower protection.

Repeatedly, residents report violation after violation with claims of “orders” from their staff, chairman, program directors and chief residents to falsify the duty logs or else. The burden of proof has fallen upon the resident rather than those responsible for their teaching. The residents have become more accountable to the ACGME than the programs themselves. Residents have become more concerned about time cards reflecting an 80-hour work week rather than concentrating on the care of their patients. The ACGME is fully aware of these violations and the widespread “cover-up” occurring across the country. They are also aware of the impending governmental take-over and imminent federal control of resident work hours if the ACGME does not do something to minimize these problems. In effect, the ACGME has become hyper vigilant in their efforts to “catch” programs in the act of non-compliance. With the ACGME cracking down on programs, the manner in which they can achieve 100% resident compliance has become the hot topic among program directors and chairmen throughout the country. They are actively looking for an effective and efficient solution to accurately log each and every resident's hours in order to avoid stiff financial penalties and threats to their accreditation. In addition, in an effort to circumvent the pressures on residents from their superiors, a safe and accurate means of reporting violations is highly sought after.

All of these problems, with their attendant costs and operational disruptions, can be completely avoided by providing the ACGME and residency programs with a system and associated method whereby they can readily and reliably monitor and regulate programs throughout the United States objectively, in real-time and off-site, that is, from their administrative offices. This, in turn, will allow the ACGME to re-direct funds to more effective endeavors ensuring compliance while minimizing novel policing activities. And this in turn will take the pressure off the programs' chairmen, directors and especially residents. With all the subjective reporting and ambiguity removed, in addition to the automatic submission of violations, residents, programs and the ACGME will be able to maximize the 80-hour work week within the current regulatory environment.

Ultimately, residents will be able to focus first and foremost on patient care and safety rather than how much time they spend in the hospital. In addition to residents and programs, the ACGME will directly benefit tremendously from this proposed system: While the ACGME, with simple but secure access to a computer, can “spot-check” any program around the country at will and send warnings, concerns, etc., residency programs can rest assured knowing that the information under inquiry by the ACGME is accurate, current and objective. By utilizing this invention, residency programs will give the ACGME the best possible guarantee of full compliance; with the data to prove it. This will allow for a more directed and focused approach on programs who continue to remain non-compliant. The ACGME can pinpoint “problem areas” and rather than using a shot-gun approach to ensuring compliance, can clearly see, down to the resident, where a violation has occurred. By providing a method for the ACGME to easily govern and administrate policy regarding the 80 hour work week, their endorsement of this system is practically certain. With endorsement from the ACGME, every residency training program across the country will be encouraged, if not required, to implement this system in their departments. If a program refuses, they come under the scrutiny of the ACGME, who now has more time and resources to enforce their regulations.

In addition, residents and programs can openly communicate and benefit from this system by being “forewarned” of impending violations and adjust accordingly in a relatively anonymous manner. All the guess work has been removed. With its use, a resident will know exactly how many hours are left in their week and if they are in danger of violating their duty hour restrictions. With the residency program receiving the same notice of violation, those responsible for the schedule can notify the staff physicians, as opposed to the resident, and thus further relieving the pressure to falsely under report work hours.

By having one's department force the resident to temporarily leave a training facility, the resident no longer appears “weak” to their staff physician by informing them of how much time they have left on duty. This is easily accomplished via e-mail to the physician directly from the department to indicate that the resident must be relieved of clinical duty or face losing the privilege of having residents. Again, by removing the focus and pressures of whether or not compliance with regulations is maintained, residents can instead focus their commitment to their patients. This would also yield fewer errors in judgment, decision making, etc. Hourswatch.com (www.hourswatch.com), in their testimonial section, reveals the alarming number of poor medical decisions made by residents as a result of being forced to remain in the hospital beyond the guidelines even after implementation of the 80-hour work week. The ACGME is unable, with their current methods and the methods employed by residency programs, to effectively monitor and police every resident's duty hour log in the country. A new means of doing so must be developed. 80-hour work week regulations are here to stay. Apparently, by the number of state and federal bills being proposed, the pendulum of legality and enforcement has yet to complete its full arc. With studies reporting a decline in the training experience as a direct result, residents need to focus as much attention as possible on their training and ultimately competent patient care, rather than on the number of hours they are working in a given week or time period. A comprehensive method must be developed—the proposed invention is that comprehensive method.

Finally, according to the ACGME, the hours logged are specifically defined as being time spent while on clinical duty or training. By design, the proposed system only records time on-site once a transponder has been automatically “read” by a receiver. By placing receivers in the doorways of clinical and training locations, those receivers are activated only while the resident is physically within the building in which the receiver is located. Any and all extraneous time spent outside of the facility during which clinical duty is not performed (e.g., driving around looking for a parking spot, having lunch off premises, etc . . . ) is not counted towards the work hours for that time interval. In doing so, not only do residents benefit by providing additional time buffers in their work schedule (a relative increase in amount of time allowable within the hospital by having less physical time recorded if outside the facility), programs benefit as well because the residents have a greater potential for “logged clinical” time in the hospital thus maximizing their residents' 80-hour work week.

The inherent problems of the inaccurate or false self-reporting of resident work hours, the hindrance in residency training, the constant badgering of residents by their superiors, the interference and negative consequences to patient care, potential severe civil penalties and the problems and short- and long-term ramifications associated with having the fear of one's program being discredited (e.g., loss of Medicare funding, loss of accreditation, etc.) can all be eliminated by the implementation of this proposed invention. Furthermore, based on AMA policy in conjunction with the AMA-RFS, those responsible for monitoring and enforcing duty hour compliance are actively seeking for methods to safely report violations and accurate monitor time on duty, both of which are accomplished by this invention.

The proposed invention is a method for monitoring, logging, storing and, most importantly, reliably reporting this objective information to residents, residency training programs and the ACGME for compliance purposes. All of this is crucial to the effective and competent training of future doctors in America. However, such a method is currently unavailable.

3. Background Art

While the constituent technology components necessary to perform the needed functions exist, they are not assembled and strategically utilized as in the proposed invention in addressing the dire needs previously described.

In addition, presently available software does not satisfy the needs met by the present invention and thus, a global method that encompasses all the tasks necessary to complete the goals outlined herein would clearly satisfy and even exceed a long felt need in the industry, as well as underscore the failure of others.

U.S. Pat. No. 6,742,002, entitled “Computer-implemented and/or computer-assisted web database and/or interaction system for staffing of personnel in various employment related fields,” and issued on May 25, 2004, is a method, system and process for a computer-assisted staffing of employees for a client; the system collects and stores, in a relational database, a large amount of information relating to the staffing of client's projects, including employee data, firm data, and order data. For example, the system stores timesheets for the employees corresponding to the clients to which they are assigned; feedback on the employees' performances is obtained and stored; and a large amount of other information. The information can be used by clients to manage and analyze personnel functions, to manage and analyze financial functions, to select from a roster of candidate employees, and to make future projections. Additionally, the information can be used by employees to track their performance, and personnel functions such as accrued vacation. The system actively seeks information to ensure accuracy of the stored data. The databases web-enabled and is accessible via the internet.

While the general purpose of the '002 patent is to actively or directly regulate and manage the functions of the employee, the proposed invention passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 4,509,123, entitled “Automated tracking process for manufacturing and inventory” and issued on Apr. 2, 1985 is an automated tracking process for items of manufacture and inventory, in which each item and each grouping or location of items is labeled with a unique nonvolatile machine-readable code identifying a corresponding data record maintained in a programmable digital computer.

While the concept of tracking an item is common, the purpose, manner and overall analysis of the items tracked in the '123 patent is unequivocally different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 6,469,628, entitled “System and method for using impulse radio technology in the farming field” and issued on Oct. 22, 2002, is a system, electronic monitor and method that utilize impulse radio technology to enable a farmer to accurately track a position of an object (e.g., farm equipment, farm animal, farm employee) as the object moves around a farm and/or to enable a farmer to monitor a variety of parameters associated with the moving farm equipment. In addition, the system, electronic monitor and method can utilize impulse radio technology to help control either remotely or automatically one or more pieces of farm equipment.

The '628 patent is limited to radio-frequency (RF) technology and to the agricultural market. In addition, RF technology alone is insufficient for the proposed invention. Thus, the general purpose of the '628 patent is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 6,226,622, entitled “Methods and devices utilizing a GPS tracking system” and issued on May 1, 2001, is a method and system that tracks productivity, including summarization of ‘tasks performed’ for productivity analysis; the tracking capabilities of the system uses a global positioning system (GPS) and includes a complete reconstruction (graphically if desired by overlaying the positional movements on a 2 or 3 dimensional map of the location) of a series movements over a period of time; the system gathers the exact time and position information of an employee over a period of each work day and the task being worked on at any given moment of time; this data can be analyzed to determine, for example, non-productive movements, and provide a better foundation of information for productivity payroll, including the relative “difficulty” of a task.

However, the combination of expensive GPS technology and the purpose of monitoring for productivity analysis in the '622 patent is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 4,819,176, entitled “Process control and data collection system” and issued on Apr. 4, 1989, is a process control and data collection system that analyzes the data collected to provide information regarding the quality of the raw material supplied by specific vendors, the quality of production for a particular job, the efficiency and quality of the employee's work and the effective yield from raw material to final product on a batch basis; the plurality of remote stations allows correlation and tracking of the material from the beginning to the end of the process through various steps and commingling of raw materials.

The process control and data collection system of the '176 patent can analyze the data collected to determine “quality” or the raw materials used by specific vendors, and can evaluate efficiency and quality of an employee's work, but not report the employee's attendance. Thus, the '176 patent is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 6,313,745, entitled “System and method for fitting room merchandise item recognition using wireless tag” and issued on Nov. 6, 2001, is a system and method for tracking and recognizing merchandise items taken into a fitting room by a customer for providing more efficient customer assistance; each merchandise item is attached to a wireless tag including a product identifier; a fitting room is equipped with an antenna/receiver unit which recognizes the wireless tag of an item taken into the fitting room to be tried-on; a store server retrieves information about the item based on the product identifier, and presents such information to a store clerk through an in-store terminal; the server presents the recommendations to a store clerk via the in-store terminal; an employee ID card or tag also allows the system to track employees assisting the customers.

The purpose of the '745 patent is for a more efficient retail customer assistance by merchandise tracking via the use of a wireless tag (transponder), but in no way for the reporting of an employee's attendance. Thus, the '745 patent is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 5,311,423, entitled “Schedule management method” and issued on May 10, 1994, is a method of managing information used and generated in the scheduling and exhibition of performances. A video network includes a video server that operates several video recorders to simultaneously exhibit video performances or programs on a plurality of channels. The video server is controlled in real time in accordance with data presented to it in an exhibition plan. The exhibition plan is generated through the performance of an exhibition manager process which operates on a computer. The exhibition manager manages information related to the performances to be exhibited, schedules the performances in accordance with user-supplied timing data, prints reports, and maintains a personal information manager having a database describing studios, contacts, and other information related to licensing the performances for exhibition on the network. The information related to performances includes repeat factors and short titles which the exhibition manager calculates. The scheduling activities of the exhibition manager automatically schedule repeated exhibitions of a performance in accordance with the performance's repeat factor. An inventory manager takes the exhibition manager's schedule and automatically expands it to schedule individual media copies of performances. The inventory manager automatically prints purchase orders and tracks media copies after they are received. Unique codes are affixed to the media copies and to the places where the media copies might possibly reside. Portable scanners are used to associate an employee id, a media copy code, a location code, and a date and time stamp together to track inventory and to provide accountability for the media copies.

The purpose of the '423 patent is for asset tracking and providing accountability with regards to possession; its use of portable scanners necessitates the active input and focused activity of purposeful movement for the successful completion of its intended task. Thus, the '423 patent, a highly active process, is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 4,270,043, entitled “Methods of and apparatus for time clock recording and computation and related uses” and issued on May 26, 1981, discloses a time-clock recording and computation that, through a novel clock track card and separate clock track and data channel optical reading, in cooperation with microprocessor calculation, storage and control, enables automating employee time and attendance and similar data in a format directly recordable on the card and also directly useable by payroll or other processing computers and the like.

Patent '043, while relating to employee work hours, requires active participation by the employee beyond that which would be required in order to attend their respective workplace (other than walking through the door). Also, patent '043 utilizes a time clock based system (start at 9 leave at 5) and not simple monitoring of the total summation of hours while “on-site,” like the proposed invention. Thus, the '043 patent, designed for financial reimbursement, is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 6,356,875, entitled “Integrated production tracking and pay rate calculation system” and issued on Mar. 12, 2002, is a system and method for an integrated production tracking and pay rate calculation system; the system evaluates department and employee productivity by tracking production of all products and hours worked by all employees.

The purpose of the '875 patent is to ascertain cost/unit as a function of labor cost, which is directly related to employee “on-site” attendance; the monitoring of work hours is to calculate productivity and not for determining attendance, like the proposed invention. Thus, the '875 patent is very different form the proposed invention and does not collect or report data, like the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

U.S. Pat. No. 6,119,097, entitled “System and method for quantification of human performance factors” and issued on Sep. 12, 2000, is a method and apparatus that enables a supervisor to quantify job performance characteristics; if the objective standards are not being met, the objective standards are re-evaluated to determine if they are realistic, and if they are, then new activities are assigned which should enable the person to meet the original or modified objective standards.

The purpose of patent '097 is to determine job performance by requiring extensive active input of the employee; the performance characteristics are based on subjective input from employees, while the proposed invention is based on objective information received via passive means. One of the explicit advantages of the proposed invention is that it bypasses subjective input from employees. Thus, the '097 patent is very different from the proposed invention, which passively, objectively and accurately monitors the hours worked by medical or surgical residents while on “clinical duty,” logs that time spent on duty and reports compliance with regulatory entities. Thus, unlike this patent, the proposed invention exceeds an unfilled need that is integral in medical and surgical training and health care delivery.

### SUMMARY OF THE INVENTION

In view of the compelling, but not-yet-satisfied needs described above, it is an object of the present invention to provide a novel instrumental system and associated method to accurately, passively and objectively monitor, log, store and report resident attendance to the appropriate authorities for compliance purposes.

It is another object of the present invention to provide a novel instrumental system and associated method to accurately, passively and objectively report any violations of compliance of current regulations to the appropriate authorities.

It is another object of the present invention to provide a novel instrumental system and method to allow medical and surgical teaching institutions and residency programs to monitor and prevent Accreditation Council for Graduate Medical Education (ACGME) 80-hour work week violations before they occur, while relieving the burden of subjective and potentially false time-reporting by medical and surgical residents.

It is another object of the present invention to provide a novel instrumental system and method such that when the present invention is in operation, then unannounced site visits and related internal audits of work hours by the ACGME and the Residency Review Committees (RRC) will be completely obviated and thus, freeing their resources to more needy areas of administration.

It is another object of the present invention to provide a novel instrumental system and method that allows medical and surgical residents to consistently achieve 100% compliance with ACGME guidelines by being automatically forewarned before a violation occurs.

It is another object of the present invention to provide a novel instrumental system and method that allows residency programs to consistently avoid monetary and accreditation penalties due to excess work hours by any resident by being automatically forewarned before a violation occurs.

In satisfaction of these and related objectives, Applicant's present invention provides an effective and efficient means to objectively, passively and accurately monitor and store medical and surgical resident attendance while on “clinical duty” and report such activity and any compliance violations of ACGME regulations to the resident, the residency program and the ACGME via electronic transmissions.

In order to achieve all goals of the proposed invention for the purpose of monitoring, logging, storing and reporting resident attendance while on clinical duty, the ideal system will utilize a combination of RF and IR technology. The advantages of both technologies can be exploited while minimizing their disadvantages. By providing a system that can overcome physical barriers innate to operating within environments that possess a plurality of situations that might render one technology inoperable, or cause it to operate in substandard conditions (e.g., a lead-lined x-ray facility, interrupted line-of-sight), one can ensure accurate and objective reporting of resident attendance during all phases and locations of clinical duty.

While RF technology may remain the standard by which most entities record attendance, the limitations of distance from the receiver when utilizing the components required in this setting is a major drawback. By providing a “backup” to substandard, yet reliable technology, one can ensure that accuracy in reporting can be maintained and maximized. In regards to IR technology, practical considerations limit an otherwise ideal technology, e.g., blocked transponders by backpacks, clothing, etc. as these and other circumstances may hinder the direct line-of-sight necessary for the IR technology to function optimally. Therefore, a combination of IR and RF-based technologies in the context of the present system, each providing backup of the other, is integral to the best mode for purposes of the proposed invention.

There is at least one company that provides the individual hardware (receivers, transponders, etc . . . ) and foundational software constituents which are necessary to assemble and operate the system of the present invention. However, no software is currently available that is programmed for the specific purposes of the proposed invention. Nevertheless, companies currently use, operate and license their technology to other entities that require tracking of patients, assets, employees and visitors. In addition, they also provide software for the purposes of security and access to otherwise restricted areas, which is not of concern for the purposes of the proposed invention). Companies also utilize, operate, sell and license their technology for real-time tracking of people or assets at all times within a building or facility. The proposed invention will simply note when the person walks into the building and when they walk out. The real-time physical location within the building is unknown.

As described above, no U.S. patents specifically teaches the relatively new area of resident duty hour monitoring for the sole purpose of reporting compliance to oversight entities. This is where the hardware aspect of their technology satisfies the best mode requirement of the patent. Anyone skilled in the art of installing the necessary hardware required described above can provide the proposed invention with the means of providing hospitals and residency programs with this technology. Anyone with electronic mail access or access to a customized graphical user interface representing the database that stores individual resident attendance activity (once trained) can benefit from the reporting function of the system of the proposed invention. Finally, anyone, and especially a medical or surgical resident, who passes through a door of a facility authorized by the ACGME as a location where medical and surgical training can take place (even in the event of a physical disability) can utilize the transponder associated with this system.

In order for this proposed method and process of monitoring, logging and reporting resident attendance during clinical duties to work, several generic components from existing technologies must be assembled. Several existing companies have compiled these products along with operating software specific to their own needs, but do not use them in the capacity of monitoring and logging resident attendance for reporting and compliance purposes.

The first device is the transponder. It is defined as a small non-invasive, non-biometric micro-processor based, battery-powered electronic device which is worn by a tracking subject. The transponder may be made of plastic, silicon and metallic (and glass in some cases), and is a micro-processor based, electronic device. The unit is worn by an individual and contains a distinctive digitized identifying code emitted in the form of physical energy (RF/IR), which is unique to the device. The device itself generates a harmless, physically-based signal (radio wavelength or light radiation/wavelength) and continuously or intermittently (depending on the specific manufactured device used) emits this signal from the device regardless of its location in a multidirectional manner.

Once a transponder producing this signal passes in close proximity to a receiver (described below) specifically designed to accept and be activated by this specific physical signal, the signal is “read” by the receiver and subsequently “activates” the receiver to perform the function for which it was specifically designed and programmed to do (capture and decipher the physical signal, relay the information, etc. to a record-keeping system, all based on the unique characteristic of the physical signal which was presented to the receiver). In doing so individual transponders can activate a plurality of receivers designed to accept a specific type of physical signal but only do so when they have come in either close physical proximity or direct line of sight (based on the tolerances and specifications of the device), thus indicating that a specific transponder has activated a specific receiver in a physical location.

The types of signals that can be emitted from a transponder vary tremendously. The majority of those commercially available include Infrared Radiation (IR), Radio Frequency (RF), GPS (Global Positioning Satellite, which behaves more like a reader), high-frequency, high-energy transmitters and nanotechnology-based. Not all of these apply to the proposed invention due to their cost, availability, size and, in some, unperfected technology. For the purpose of this art, two methods of physical transponding signals will be discussed: Radio frequency (RF) and Infrared Radiation (IR).

Radio Frequency (RF) devices utilize low energy radio waves that are emitted from the transponder and “read” by a specifically designed receiver made for receiving this specific type, frequency and wavelength of radio waves. A predetermined, federally-regulated and pre-programmed radio wavelength and radio frequency is emitted from the transponder and received via antenna by the RF receiver device tuned to the same frequency and wavelength. Upon activation of the receiver and charging of an internal capacitor within the transponder via pulsed radio frequency by the receiver a second set of pre-programmed digitized information is transmitted via radio frequency from the transponder to the receiver. The unique information emitted from the transponder enables a plurality of receivers to identify the transponder and carry out various tasks based on the information provided via radio frequency.

While some RF transponders contain their own power source, such as a battery, the majority of personal RF transponders that are in use commercially contain a capacitor which is recharged every time the transponder is in “communication” with the receiver. It is for the latter reason that in most RF devices there appear to be a time interval between placing the card on the receiver and the activation of the audible confirmatory report (a “beep” sound). Not only is the receiver “reading” the card but it can only do so after the capacitor has been charged and there is sufficient power in the transponder card to transmit an additional digitized signal, which contains the pertinent information unique to the transponder. The advantage of RF technology is related to the maturity and reliability of the technology and the relative low overall cost of the materials and commercially available products. The disadvantage, however, is that in order to optimize size, safety, cost and availability, this technology is limited to relatively low amplitude and low frequency radio signals, which can only travel short distances (usually less than 2 meters) due to the limited power source (capacitor) available in the transmitters within the transponders. Another significant disadvantage is that RF technology is susceptible to interference from surrounding natural energy sources if a larger range of detection and transmission is required.

Infrared Radiation (IR) devices, on the other hand, while newer in regards to their use in transponder innovation, the technology has been around for many years. Unlike RF technology, IR technology activates receivers via continual or intermittent impulses of harmless infrared radiation signals emitted from the transponder, which are modulated or encoded with unique identifying data much like the second pulse of the RF device. Also, other pertinent transponder specific information is transmitted via infrared radiation. In addition, the multidirectional spherical shaped receivers necessary for IR transponders differ from those required for RF technology based on the type of physical energy they are receiving.

While not visible to the human eye the specific digitized impulse of infrared radiation unique to the transponder can be received and “read” by the receiver as long as a direct or partial line of site is maintained between the transponder and the receiver. Most IR devices available for this purpose require a battery source in order to produce and emit an electromagnetic pulse strong enough to travel any significant distance. They require too much power to be recharged with a standard capacitor, like that of an RF device, and thus require their own power source.

The advantages of IR transponders and the technology surrounding their production is their relative resistance to the interference that RF technology is susceptible to. As long as a direct line of site is maintained for the fraction of a second during which the digitized infrared signal is being transmitted, and the transponder is within the range of the receiver (up to 8 meters, depending on the size of the power source for the transponder), outside interference is not of concern. In addition, and probably the most important difference and advantage IR has over RF is the range in which these signals can operate (8+ meters effectively).

With a much larger signal fewer receivers are required (in the event of real-time positional tracking) and the limitations imposed upon RF receivers in regards to location and close proximity to transponders is no longer an issue. Because of a direct line of sight relay of infrared signals, the receiver can be mounted in relatively unobtrusive, indistinct or non-disclosed locations for security purposes. Also, with IR technology, the transponders emit pulses of infrared radiation as they are always on the “look-out” for IR receivers. While IR technology sounds flawless for this task, there are some disadvantages to this “active” tracking system. The cost of the IR-based systems may be the primary shortcoming to IR technology, while the requirement of a dedicated power source (usually a battery with a three year life span based on average use) is another significant shortcoming. Also, in areas where lines of sight to receivers may be compromised, this system proves less than perfect.

The receiver, either RF or IR based, or one combining features of both, constitutes the other half of tracking systems according to the present invention. While the signal, either RF or IR, is generated and emitted from the transponder, it is useless without any method of capturing physical signals, transforming those signals into digitized electrical signals and relaying them to a micro-processor based computer capable of interpreting, storing and “acting” upon the received electronic signal. Typically, the signal or signals emitted from the transponder “activates” a sensor within the receiver unit based of the specific design and innate capturing equipment of the receiver.

In IR technology the received physical energy is infrared radiation and in RF it is a particular frequency of radio waves. Upon “accepting” or receiving the signal, a transducer within the receiver must convert those physical signals, either infrared radiation or radio waves, into an electrical signal and then propagate those signals to a micro-processor based computer via standardized hard-wiring (physical electronic connection). It can then interpret, store and/or appropriately “act” upon those electrical signal as programmed to do so. As stated above, the advantages and disadvantages of each system is based upon the innate limitations of the technology in which the receiver is based.

In the case of RF technology the advantages include its relative low cost, matured technology, and numerous types of receivers that can be installed to accept RF from the transponders. The major disadvantage is the limited physical range in which the RF receivers can effectively and efficiently operate. In contrast, for IR technology, the receivers are much more effective at longer ranges from the transponder and as such, represent a major advantage over RF technology for this fact alone. However, their cost and relatively new technology may prove to limit the practicality of its use.

The final aspect of this tracking technology is the manner by which the generated physical signals and subsequent electrical signals (once converted by the receiver) are propagated to computers. Such propagation is made via standard hard-wiring by a plurality of receivers located within an individual building or location in which the receivers are networked and stored by the computer via programming specifically designed for the purposes dictated by the software installed on the computer. The electronic signals received by the computers designed and manufactured to receive these signals will then be included within a plurality of functions based on the programming by which the creators of the software intended.

### BRIEF DESCRIPTION OF THE DRAWINGS

FIG. 1—sample network illustration. This figure is sample network illustration of the proposed invention, which illustrates a typical setup at a given teaching institution with four (4, labeled Facility A, B, C, D) teaching facilities and a master (or institutional) server. The master server is located at a secure location within the teaching institution. It can be accessed from any remote location that has internet access and when the user has the proper username and password.

FIGS. 2 and 3—assignment and logging time on duty. This flow chart delineates activation of the proposed invention. Specifically, the flow chart describes how programs distribute transponders, how they are assigned to residents and how the receivers enter the data into the database for each teaching facility.

FIG. 4—Compiling of databases into the master server, monitoring of individual transponders and generation of reports. This flow sheet depicts how the duty hours are compiled from each teaching facility into a master server for the institution, how reports are generated and how those in the ACGME, residents, and authorized individuals can access and monitor the hours logged for each transponder.

FIG. 5—reporting of weekly and monthly duty hour violations to all parties involved. This flow sheet describes how violations in duty hours (call violations, as well as consecutive hours in-house violations, can be deemed “duty hour violations”) are transmitted to residents, program directors, chairman, authorized persons responsible for monitoring and the ACGME.

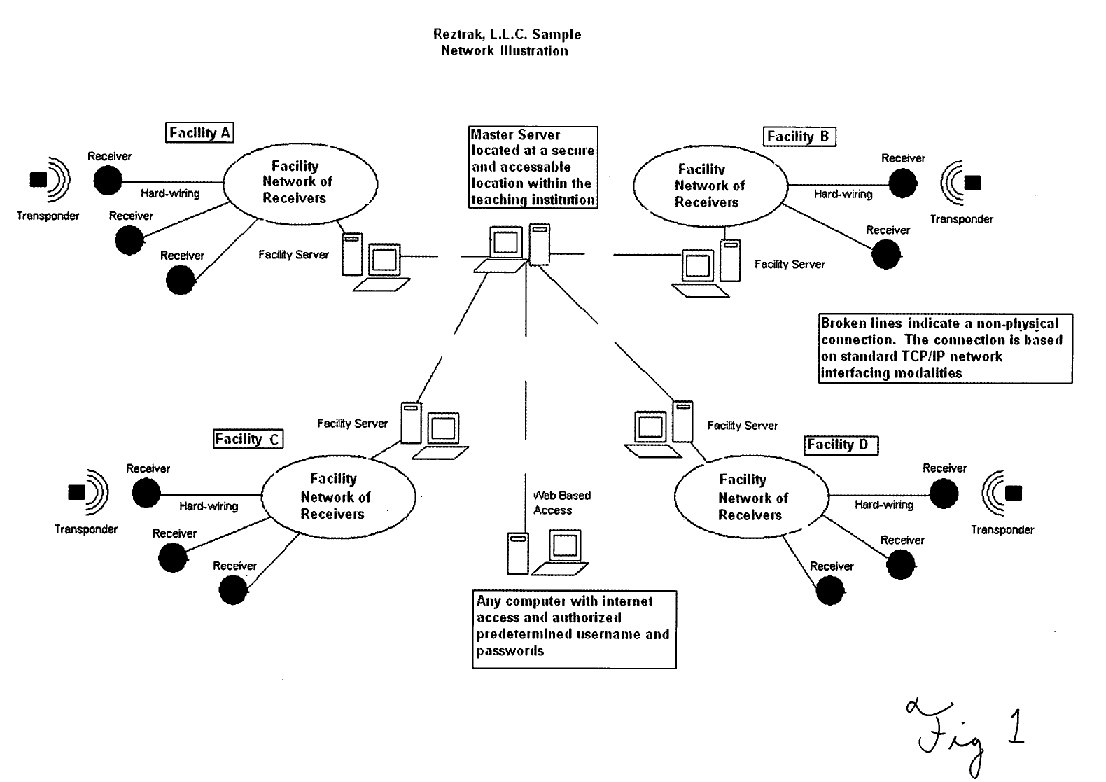

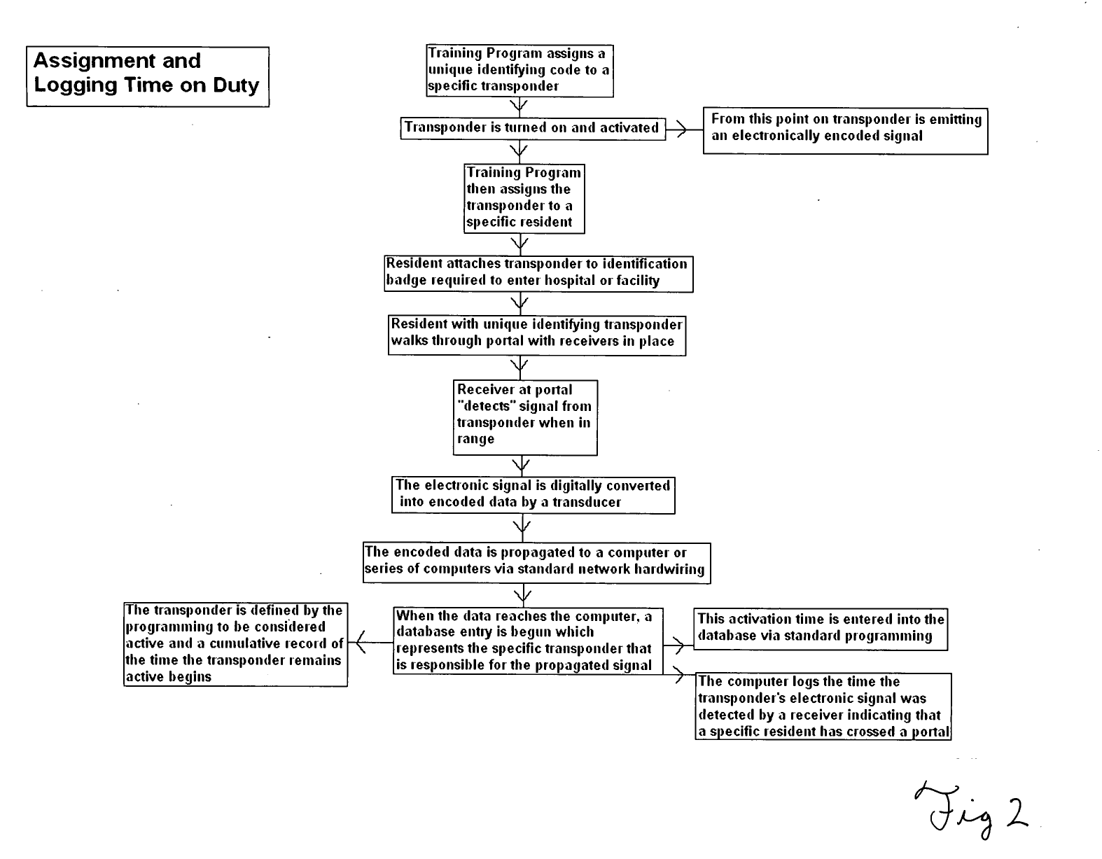

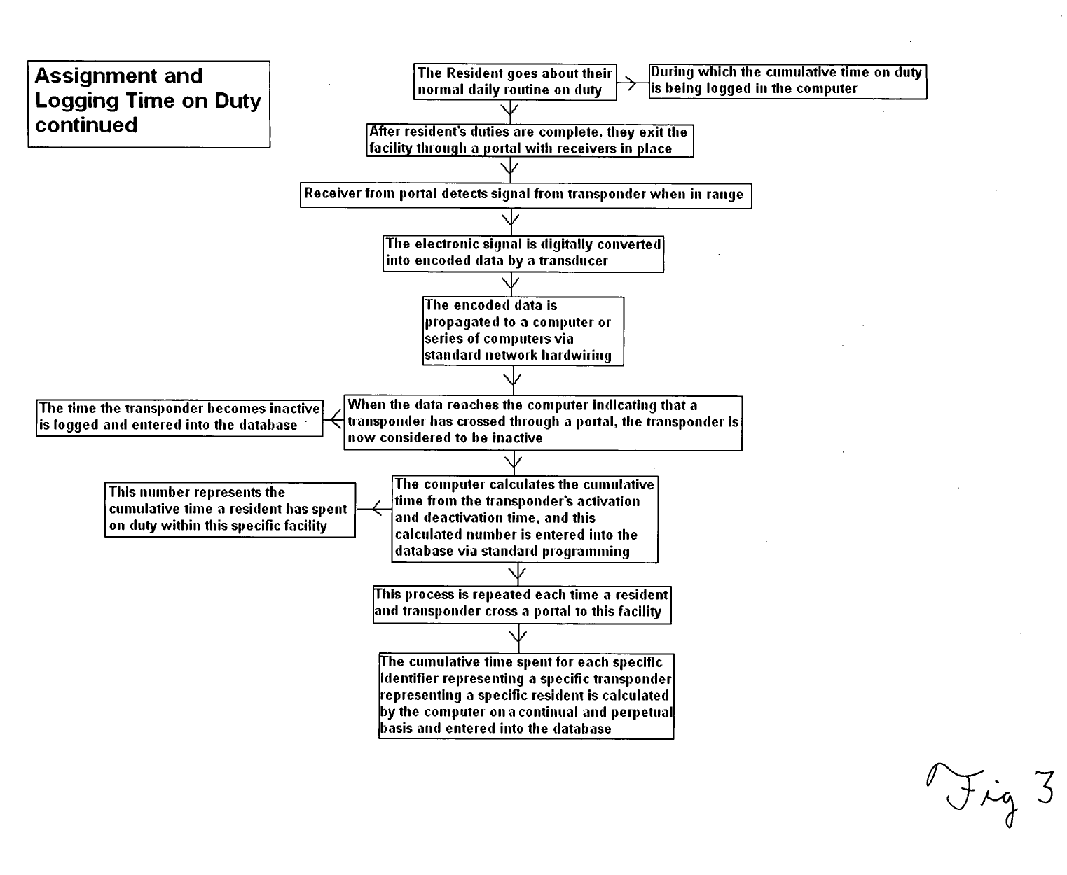

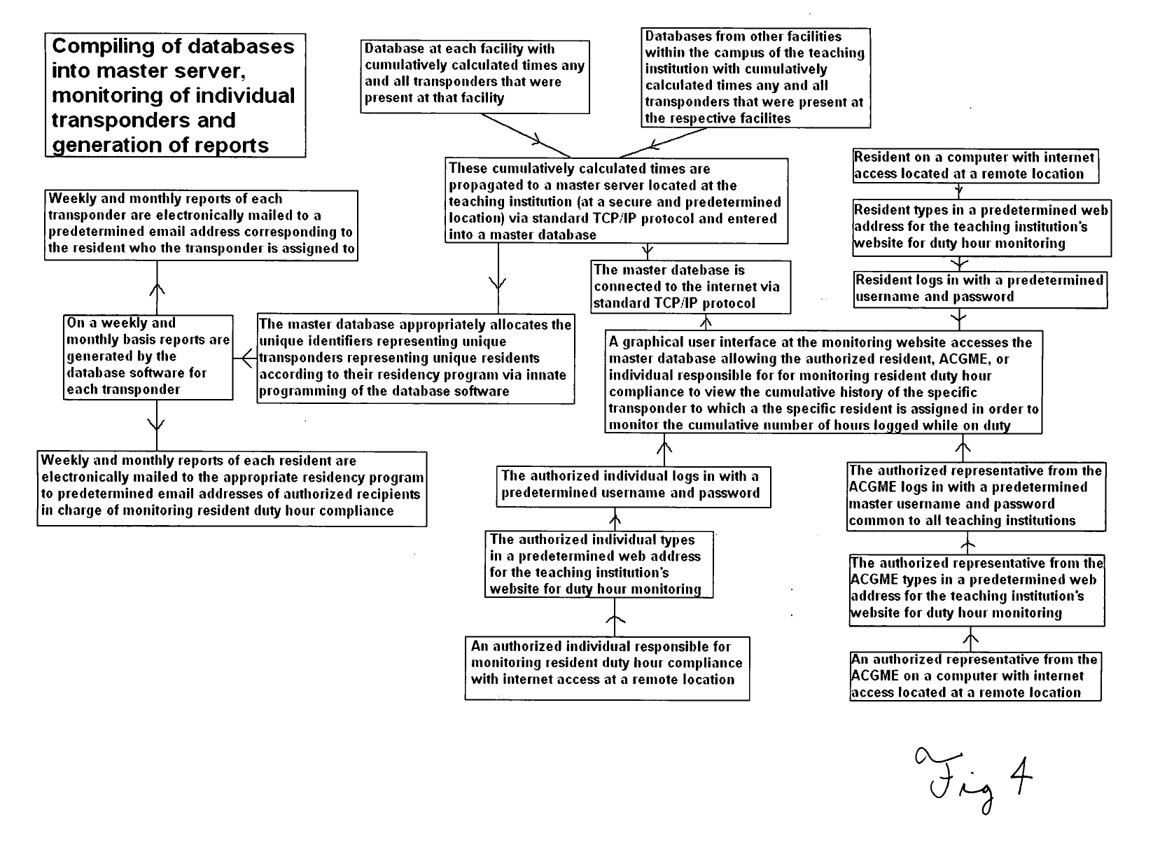

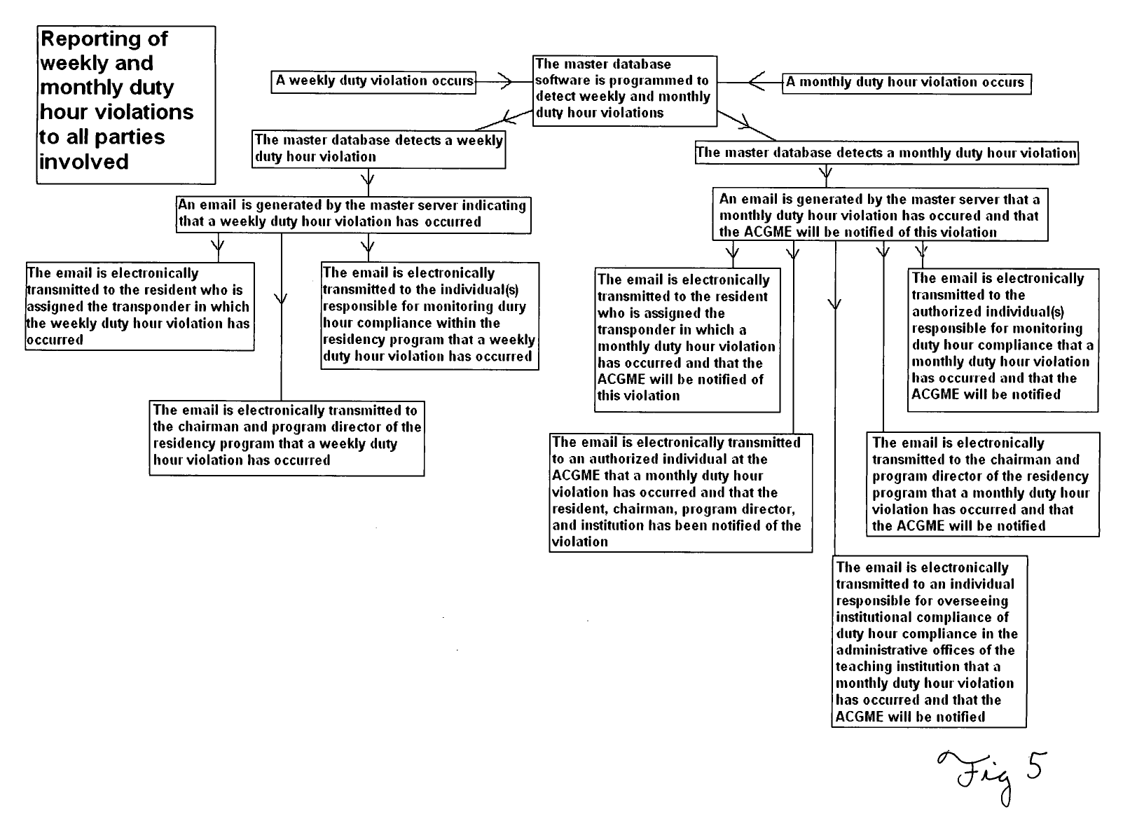

### DETAILED DESCRIPTION OF THE PREFERRED EMBODIMENT

The primary purpose of the proposed invention is to provide real time capabilities for passively monitoring, logging and reporting residents' attendance (as herein defined) to accreditation committees for compliance purposes. This is vitally important to ensure residency program compliance of the 80-hour work week, as outlined in federal legislation and enforced by the ACGME without the active involvement of the resident (apart from walking through a doorway equipped with a reader). An electronic transponder device, which will be worn by each resident, will have a unique electronic code embedded within the hardware, which will subsequently be emitted from the device in the form of a physical signal (either as RF or IR) unique to the wearer of the transponder.

Once generated and transmitted via the transponder, the appropriate receiver located within a network of receivers representing a physical building or location pre-determined by the designers of the network will accept those physical signals. The receiver will then convert them via a transducer into electrical signals and propagate those electrical signals to a computer. Such computer is designated as the server responsible for monitoring and logging attendance in a particular building or location, which is set forth in the original design of the network via standard hardwiring and network capable devices (as described above).

The computer responsible for the receiver (server) located within a pre-determined network of receivers will then log the physical time the unique transponder signal (which represents a unique resident via pre-determined individual identifying means) activated the receiver representing what time the resident entered or exited the building in which the receiver is located. If the time recorded by the computer represents the time the resident entered the location in which the receiver was located the computer software associated with the server the receiver is hard-wired to will remain “active” via the software installed on that particular computer. The duration of time from activation of the receiver by the resident's transponder will then be logged and cumulatively determined until a receiver within the same network is re-activated by the transponder, which originally activated the receiver. This process will be repeated for each individual transponder in the same manner.

Each facility within the residency training program authorized and accredited by the ACGME to provide medical and/or surgical training to residents will contain a network of receivers located at all portal entrances and exits, including fire exits. This will be represented by a computer/server responsible for the logging of time by receipt of electrical signals received by a plurality of receivers within the building or location to which the server is responsible. A network of servers (representing individual facilities, locations or buildings) will be governed by a “master” server responsible for the storing and reporting of all information/data received by servers once compiled over a predetermined timeframe and cumulatively determined from individual networks (representing individual buildings, locations or facilities).

The “master” server will then report all cumulative times of logged and recorded activity to the residency programs' administrative offices responsible for individual transponders. The embedded code within the transponders provides an indirect method of identifying individual persons based on predetermined assignment, typically by a resident's residency program, of a unique identifying code with the individual wearing the transponder and thus, enabling the residency programs to monitor only their residents.

Each resident will have an identifying code unique to the transponder that is attached to their clothing, which will be issued to them at the onset of their employment or rotation through a designated training facility by their respective residency program. Unless otherwise specified, the resident will continue to utilize the original transponder assigned to them by their respective residency program. As such, their attendance will be monitored, logged and reported by the residency program in which their employment contract is administered. The training program responsible for the training of that specific resident within a specific medical or surgical specialty will be able to monitor and track the attendance of that particular resident. Such passive tracking is based on the activation of a receiver and subsequent data generated when the resident walks in proximity or direct line of sight to the receiver with no additional active participation on behalf of the resident required. This compiled data will be cumulated and stored on the master institutional server and via the innate code of the programmed software installed on the master institutional server and will generate scheduled reports, and in the event of duty hour violations-warnings, and electronically transmit those reports to the residency program administrative offices to an authorized individual(s) responsible for the oversight of resident attendance, the program director and/or chairman, the resident and in the event of a monthly duty hour violation to the ACGME all via electronic mail. In order to provide comprehensive information of all residents within a residency program, these servers (including the master server) and individual facility servers (as defined above) will be “connected” via standard, commercially available and manufactured TCP/IP based networks. Thus is, in essence, creating a single entity representing a plurality of hospitals, buildings, clinics, a single specialty residency program or an entire medical college of facility responsible for training residents. The design of the network will be contractually determined, based upon needs and physical properties of the buildings, locations, individual programs and/or medical facilities.

Finally, the data from each transponder for each individual resident will be transmitted to a central “master” server, which will maintain and store the cumulative attendance logs over a predetermined time interval (typically weekly and monthly). All correspondence relating to resident duty hours in the form of electronic mail will be generated automatically via software programming installed on the master institutional server. These logs of resident attendance will be accessible at any time by authorized individuals from participating residency programs, program directors and/or chairman, the resident themselves and the ACGME. Ideally, software will be designed which will program the “master” server to transmit “warning” messages in the form of electronic mail of impending 80 hour work week non-compliance infractions to the resident and the residency program responsible for that resident. In the event of any violation of the 80-hour work week according to ACGME regulations a message in the form of electronic mail will be sent to the resident, the residency program and the ACGME. Any action taken by the resident, the residency program and/or the ACGME will be determined on a case-by-case basis by the involved parties. The purpose of this system is to objectively provide a real-time method to monitor, log, and report resident duty hours over a specified and predetermined timeframe. Once compiled over the predetermined timeframe, the cumulatively determined values of medical and surgical residents' attendance during authorized clinical duty and/or any violations of the guidelines set forth by the ACGME by the resident or the residency program will be sent within an embedded email to the ACGME in an effort to ensure compliance with regulations resulting form recently passed state and recently proposed federal legislation.

By ensuring compliance with the ACGME regulations, residents and residency programs can provide uninterrupted and optimum medical and surgical training and patient care.

Currently, there are many companies that provide transponders that could accomplish the purpose of the proposed invention. These various transponders can be categorized on the type of technology they utilize in order to emit an electronic signal, the range/proximity in which the device is designed to normally and efficiently operate and the physical properties of the device (including but not limited to, size, weight, ease of use, etc.).

In order to maximize the effectiveness of this device, the transponder used will need to be relatively small and have the ability, by design, to be attached to a garment of a resident via a lanyard or other attachment device without hindering or otherwise obstructing any ability of the resident in his/her clinical duties. Currently, several companies offer a small non-obtrusive device that can be worn on a lanyard already containing identification cards required to be worn at all times by residents in order to gain access to the building in which clinical duties are performed, as well as other physical locations within the building restricted to normal pedestrian/visitor traffic, e.g., surgical suite, pediatric ICU, adult ICU, neonatal ICU, Emergency Center, etc.

These transponders are relatively low profile and consist of micro-processor based technology, which utilizes RF, IR or a combination of the two. There are patents used for this purpose. The advantages and disadvantages of these technologies are discussed above. The receivers used to receive the physical signals generated and emitted from these transponders are also commercially available. Companies exist that provide the hardware and software for managing employee tracking.

All hardware utilized to accomplish the purpose of the proposed invention is available. The software required to maintain, log and report the attendance of employees is also available and is typically offered as part of the package that includes the transponders and receivers. (Plans are underway to create programming specific to the purposes set forth in this proposed invention to log, monitor, store and report resident attendance while on clinical duty.) The servers or computers in which this software may be installed for the proposed invention are offered by these companies or can be built by a multitude of vendors. The materials used for hardwiring the receivers to the servers are also available, as is the hardware necessary to provide a wireless or phone-based network of all servers involved. Standard cabling (CAT3-5), 10 BaseT Network devices, stand alone AC power supplies, etc. are commercially available.

Although the invention has been described with reference to specific embodiments, this description is not meant to be construed in a limited sense. Various modifications of the disclosed embodiments, as well as alternative embodiments of the inventions, will become apparent to persons skilled in the art upon the reference to the description of the invention.

It is, therefore, contemplated that the appended claims will cover such modifications that fall within the scope of the invention.

I claim:

1. A method for monitoring and memorializing surgical and medical resident on-site activities comprising the steps of:
selecting first transponder means, said first transponder means configured for communications with receiver means via IR and RF transmission mediums, said communications including the transmission by said transponder means, and the reception by said receiver means of a first transponder-specific identifying data sequence, said first transponder means being configured for carriage by a first human host;
selecting a first said receiver means, said first receiver means being configured for said communications with said first transponder means via IR and RF transmission means, said first receiver means further being associated with data processing means and operating systems, in turn, configured for, upon each reception of said first transponder-specific identifying data sequence from said first transponder means, creating a distinct data record on an interfaced computer means which reflects both said first receiver means' reception of said first transponder-specific identifying data sequence and the time and date of such reception;
providing said first transponder means to a first medical or surgical resident for wearing on garments or other carriage;
installing and positioning said first receiver means at a first location of a medical facility in proximity to which first location the juxtaposition of said medical or surgical resident will cause the creation of a said data record which reflects the physical presence of said medical or surgical resident at a later-determinable time and date;
periodically examining data record(s) created by said first receiver means and ascertaining the date(s) and time(s) when, by creation of each said data record, said medical or surgical resident, in possession of said first transponder means, is indicated by said data record(s) to have been in proximity to said first receiver means.

2. The method of claim 1 further comprising the steps of:
selecting a plurality of additional transponder means, each of said additional transponder means being respectively configured for communications with said first receiver means via IR and RF transmission mediums, said communications including the transmission by each said additional transponder means, and the reception by said first receiver means of a respectively unique transponder-specific identifying data sequence, and wherein said first receiver means is configured for said communications with each of said additional transponder means via IR and RF transmission means, and wherein said first receiver means is further configured for, upon each reception of a respective said unique transponder-specific identifying data sequence, creating a distinct data record which reflects both said receiver means' reception of each said unique transponder-specific identifying data sequence and the time and date of each such reception and providing each of at least a portion of said additional transponders means respectively to a number of medical or surgical residents for facilitating the ascertaining of date(s) and time(s) when, by creation of each said data record, each respective medical or surgical resident, in possession of each respective said additional transponder means, is indicated by said data record(s) to have been in proximity to said first receiver means.

3. The method of claim 1 further comprising the steps of:
selecting a plurality of additional receiver means, each said additional receiver means being configured for said communications with said first transponder means via IR and RF transmission means, each said additional receiver means further being associated with data processing means and operating systems, in turn, configured for, upon each reception of said first transponder-specific identifying data sequence from said first transponder means, creating a distinct data record which reflects both said additional receiver means' reception of said first transponder-specific identifying data sequence and the time and date of such reception;
installing and positioning each said additional receiver means at a respective locations of a medical facility in proximity to which locations the juxtaposition of said medical or surgical resident will cause the creation of a said data records which reflect the physical presence of each said medical or surgical resident at a later-determinable time and date.

4. The method of claim 2 further comprising the steps of:
selecting a plurality of additional receiver means, each said additional receiver means being configured for said communications with each of said transponder means via IR and RF transmission means, each said additional receiver means further being associated with data processing means and operating systems, in turn, configured for, upon each reception of said transponder-specific identifying data sequences from each said transponder means, creating a distinct data record which reflects both said receiver means' reception of said transponder-specific identifying data sequences and the time and date of each such reception;
installing and positioning each said additional receiver means at a respective locations of a medical facility in proximity to which locations the juxtaposition of each said medical or surgical resident will cause the creation of a said data records which reflect the physical presence of each said medical or surgical resident at a later-determinable time and date.

5. The method of claim 3 wherein each of a plurality of said receiver means is associated with a data processing system which is configured for aggregating said data records generated as a result of respective receptions of respective said unique transponder-specific identifying data.

6. The method of claim 1 further comprising the step of selecting remote log-in means associated with said data processing means by which said data records may be accessed via a remote computer.

7. The method of claim 2 further comprising the step of selecting remote log-in means associated with said data processing means by which said data records may be accessed via a remote computer.

8. The method of claim 3 further comprising the step of selecting remote log-in means associated with said data processing means by which said data records may be accessed via a remote computer.

9. The method of claim 4 further comprising the step of selecting remote log-in means associated with said data processing means by which said data records may be accessed via a remote computer.

10. The method of claim 1 wherein said periodically examining data record(s) created by said first receiver means and ascertaining the date(s) and time(s) when, by creation of each said data record, said medical or surgical resident, in possession of said first transponder means, is indicated by said data record(s) to have been in proximity to said first receiver means is performed by said computer means, and wherein said computer means is configured: (1) for calculating cumulative time, during one or more user-defined time frames, that a said medical or surgical resident is indicated as having been on-premises of a monitored medical facility; and (2) for generating a user-perceptible report of such calculations.

11. The method of claim 10 wherein said computer means is further configured for transmitting via an interfaced data network, to a user-defined recipient, data representative of said cumulative time when said cumulative time exceeds a user-defined maximum sum.

12. The method of claim 10 wherein said computer means is further configured for receiving and providing a report reflective of information responsive to queries, received via an interfaced data network, and pertaining to the contents of one or more of said data records.

13. The method of claim 11 wherein said computer means is further configured for receiving and providing a report reflective of information responsive to queries, received via an interfaced data network, and pertaining to the contents of one or more of said data records.

14. The method of claim 2 wherein said periodically examining data record(s) created by said first receiver means and ascertaining the date(s) and time(s) when, by creation of each said data record, each said medical or surgical resident, in possession of said transponder means, is indicated by said data record(s) to have been in proximity to said first receiver means is performed by said computer means, and wherein said computer means is configured: (1) for calculating respective cumulative times, during one or more user-defined time frames, that each said medical or surgical resident is indicated as having been on-premises of a monitored medical facility; and (2) for generating a user-perceptible report of such calculations.

15. The method of claim 14 wherein said computer means is further configured for transmitting via an interfaced data network, to a user-defined recipient, data representative of said cumulative time or times when said cumulative time or times exceed a user-defined maximum sum.

16. The method of claim 14 wherein said computer means is further configured for receiving and providing a report reflective of information responsive to queries, received via an interfaced data network, and pertaining to the contents of one or more of said data records.

17. The method of claim 15 wherein said computer means is further configured for receiving and providing a report reflective of information responsive to queries, received via an interfaced data network, and pertaining to the contents of one or more of said data records.

18. A system for facilitating the monitoring and memorializing of on-site activities of surgical and medical residents comprising:
first transponder means, said first transponder means configured for communications with receiver means via IR and RF transmission mediums, said communications including the transmission by said transponder means, and the reception by said receiver means of a first transponder-specific identifying data sequence, said first transponder means being configured for carriage by a first human host;
first said receiver means, said first receiver means being configured for said communications with said first transponder means via IR and RF transmission means, said first receiver means further being associated with data processing means and operating systems, in turn, configured for, upon each reception of said first transponder-specific identifying data sequence from said first transponder means, creating a distinct data record which reflects both said first receiver means' reception of said first transponder-specific identifying data sequence and the time and date of such reception.

19. The system of claim 18 further comprising:
a plurality of additional transponder means, each of said additional transponder means being respectively configured for communications with said first receiver means via IR and RF transmission mediums, said communications including the transmission by each said additional transponder means, and the reception by said first receiver means of a respectively unique transponder-specific identifying data sequence, and wherein said first receiver means is configured for said communications with each of said additional transponder means via IR and RF transmission means, and wherein said first receiver means is further configured for, upon each reception of a respective said unique transponder-specific identifying data sequence, creating a distinct data record which reflects both said receiver means' reception of each said unique transponder-specific identifying data sequence and the time and date of each such reception.

20. The method of claim 18 further comprising:
a plurality of additional receiver means, each said additional receiver means being configured for said communications with said first transponder means via IR and RF transmission means, each said additional receiver means further being associated with data processing means and operating systems, in turn, configured for, upon each reception of said first transponder-specific identifying data sequence from said first transponder means, creating a distinct data record which reflects both said additional receiver means' reception of said first transponder-specific identifying data sequence and the time and date of such reception.

21. The method of claim 19 further comprising:
a plurality of additional receiver means, each said additional receiver means being configured for said communications with each of said transponder means via IR and RF transmission means, each said additional receiver means further being associated with data processing means and operating systems, in turn, configured for, upon each reception of said transponder-specific identifying data sequences from each said transponder means, creating a distinct data record which reflects both said receiver means' reception of said transponder-specific identifying data sequences and the time and date of each such reception.

22. The method of claim 20 wherein each of a plurality of said receiver means is associated with a data processing system which is configured for aggregating said data records generated as a result of respective receptions of respective said unique transponder-specific identifying data.

23. The method of claim 21 further comprising remote log-in means associated with said data processing means by which said data records may be accessed via a remote computer.

24. The method of claim 19 further comprising remote log-in means associated with said data processing means by which said data records may be accessed via a remote computer.

25. The method of claim 20 further comprising remote log-in means associated with said data processing means by which said data records may be accessed via a remote computer.

26. The method of claim 21 further comprising remote log-in means associated with said data processing means by which said data records may be accessed via a remote computer.
